(19) United States
(12) Patent Application Publication
(10) Pub. No.: US 2005/0171852 A1
(43) Pub. Date: Aug. 4, 2005

(54) Computerized quotation generation system

(76) Inventor: Van Daele Stephen Mabrito, San Antonio, TX (US)

Correspondence Address: Law Offices of John Chupa & Associates, P.C., Suite 50, 28535 Orchard Lake, Farmington Hills, MI, 48334, US

(21) Appl. No.: 11/012,657

(22) Filed: Dec. 15, 2004

Related U.S. Application Data
(63) Continuation of application No. 09/636,696, filed on Aug. 11, 2000, now abandoned.

(51) Int. Cl. G06F 17/60

(52) U.S. Cl. 705/20

(57) ABSTRACT

A computerized quotation system 10 which allows equipment quotation templates 400 to be selectively and efficiently created by the use of equipment display portions 70.

### (1) FIELD OF THE INVENTION

The present invention generally relates to a computerized quotation system and more particularly, to a computerized quotation system which selectively generates relatively accurate equipment quotations.

### (2) BACKGROUND OF THE INVENTION

A business enterprise often sells or offers many diverse types of equipment for sale or lease, thereby requiring the sales staff to have knowledge of the identity and associated pricing, availability, shipping, and attribute type information for each type or variety of this wide variety of equipment. Moreover, this equipment information is typically resident within a store or facility and is usually contained on paper or in a computer which is only capable of being locally accessed (i.e., accessed only at the location at which the computer resides). Further, the staff must typically “sift through” all of this information before creating a quotation by manually reproducing at least some of the contained information upon one or more “quote sheets”.

While the previously delineated approach does allow a quotation to be generated, it has several drawbacks. By way of example and without limitation, this approach is relatively inefficient due to its inability to automatically and selectively copy certain information from the equipment database onto the quotation sheets. This requirement also undesirably increases the likelihood of errantly generated quotations. This approach also does not efficiently allow the contained equipment information to be readily scanned and reviewed since the information is typically contained in relatively bulky, binder type assemblies or devices or resides in a computer system which is not adapted to allow the information to be searched by an attribute or “key word”. Moreover, this approach is also not adapted for use by mobile or traveling sales personnel since the equipment data or information is typically not computerized and not accessible by those remotely located from it. Further, the equipment information is not typically and readily updated, thereby causing errant quotations to be undesirably generated and is not generally adapted for use with a global communications network, such as the Internet.

### SUMMARY OF THE INVENTION

It is a first object of the present invention to provide a computerized quotation system which overcomes some or all of the previously delineated drawbacks of prior quotation systems.

It is a second object of the present invention to provide a computerized quotation system which overcomes some or all of the previously delineated drawbacks of prior quotation systems and which, by way of example and without limitation, allows a relatively accurate quotation to be quickly and easily generated.

It is a third object of the present invention to provide a computerized quotation system which overcomes some or all of the previously delineated drawbacks of prior quotation systems and which, by way of example and without limitation, allows certain equipment information to be readily and efficiently placed within a quotation.

It is a fourth object of the present invention to provide a computerized quotation system which overcomes some or all of the previously delineated drawbacks of prior quotation systems and which, by way of example and without limitation, contains equipment information and allows the contained information to be quickly and easily scanned.

According to a first aspect of the present invention, a computerized quotation system is provided. The computerized quotation system includes at least one first portion which has equipment information; and a second portion which selectively copies at least some of the contained equipment information and which uses some of the copied information to provide a quotation.

According to a second aspect of the present invention, a method for providing a quotation is provided. The method includes the steps of obtaining equipment information; placing the information in a database; storing the database; selecting at least some of the information; providing a quotation template; and copying the selected information onto the quotation template.

These and other features, aspects, and advantages of the present invention will become apparent from a reading of the following detailed description of the preferred embodiment of the invention and by reference to the following drawings.

### BRIEF DESCRIPTION OF THE DRAWINGS

FIG. 1 is a block diagram of a computerized quotation system which is made in accordance with the teachings of the preferred embodiment of the invention;

FIG. 2 is an illustration of a dealer information template which is used by the computer system which is shown in FIG. 1;

FIGS. 3(a-b) cooperatively comprise an illustration of the equipment information portion of the computerized quotation system which is shown in FIG. 1;

FIG. 4 is an illustration of the “totals box details” portion of the equipment information portion which is shown in FIGS. 1 and 3;

FIG. 5 is an illustration of the “salesman miscellaneous detail” portion of the equipment information portion which is shown in FIGS. 1 and 3; and

FIGS. 6(a-b) cooperatively comprise an illustration of the quotation template used by the computerized quotation system which is shown in FIG. 1.

### DETAILED DESCRIPTION OF THE PREFERRED EMBODIMENT OF THE INVENTION

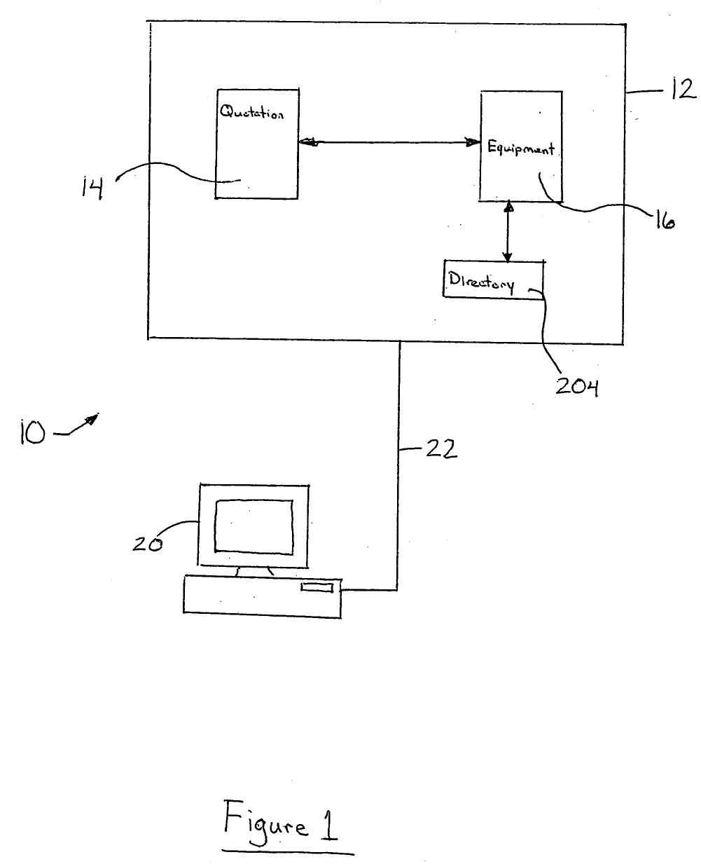

Referring now to FIG. 1, there is shown a computerized quotation system 10 which is made in accordance with the teachings of the preferred embodiment of the invention. As shown, system 10 comprises a computer 12 which is operable under stored program control and which may comprise a conventional “lap top” type computer or substantially any other type of conventional computer which is commercially available, including but not limited to, the computers which are manufactured and produced by the IBM Corporation of Armonk, N.Y.

As further shown in FIG. 1, computer 12 includes a quotation portion 14 and an equipment portion 16. More particularly, the quotation portion 14 is communicatively and controllably coupled to the equipment portion 16 such that, as is more fully and completely delineated below, at least a portion of the information which is resident within the equipment portion 16 is selectively “copied” to and/or selectively transferred to the quotation portion 14. Hence, in the preferred embodiment of the invention, both portions 14 and 16 are constructed of software and/or firmware and may be accessed and/or modified by a user by the use of a keyboard or other conventional input and/or user interface type device. Moreover, in another non-limiting embodiment of the invention, portions 14 and 16 may be remotely accessed by another computer 20 by the use of a global communications network, such as the Internet 22.

In this manner, as is more fully and completely delineated below, a user of computer 12 and/or computer 20 may selectively and remotely access the portions 14 and 16 and quickly and easily prepare a quotation and/or quickly and easily update the then currently stored information within the portions 14 and 16.

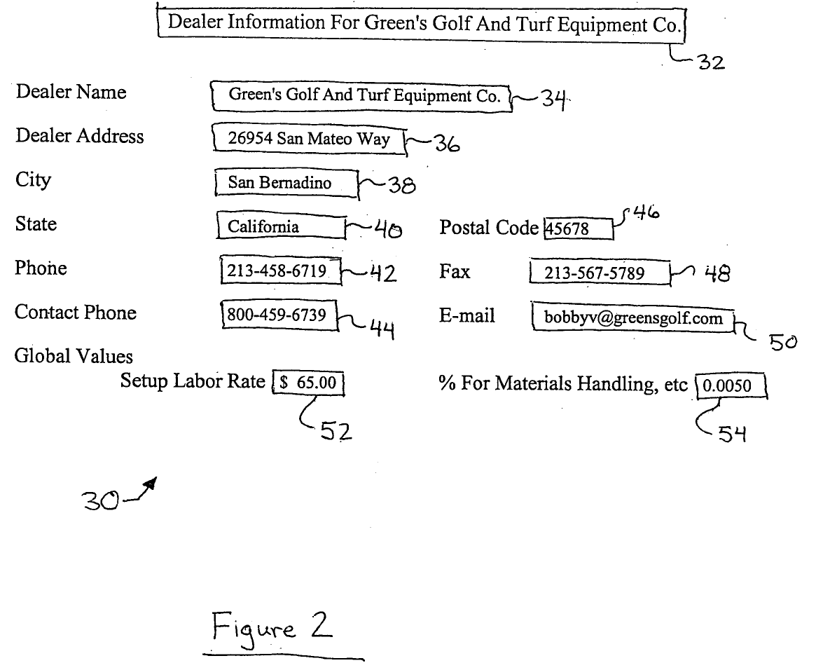

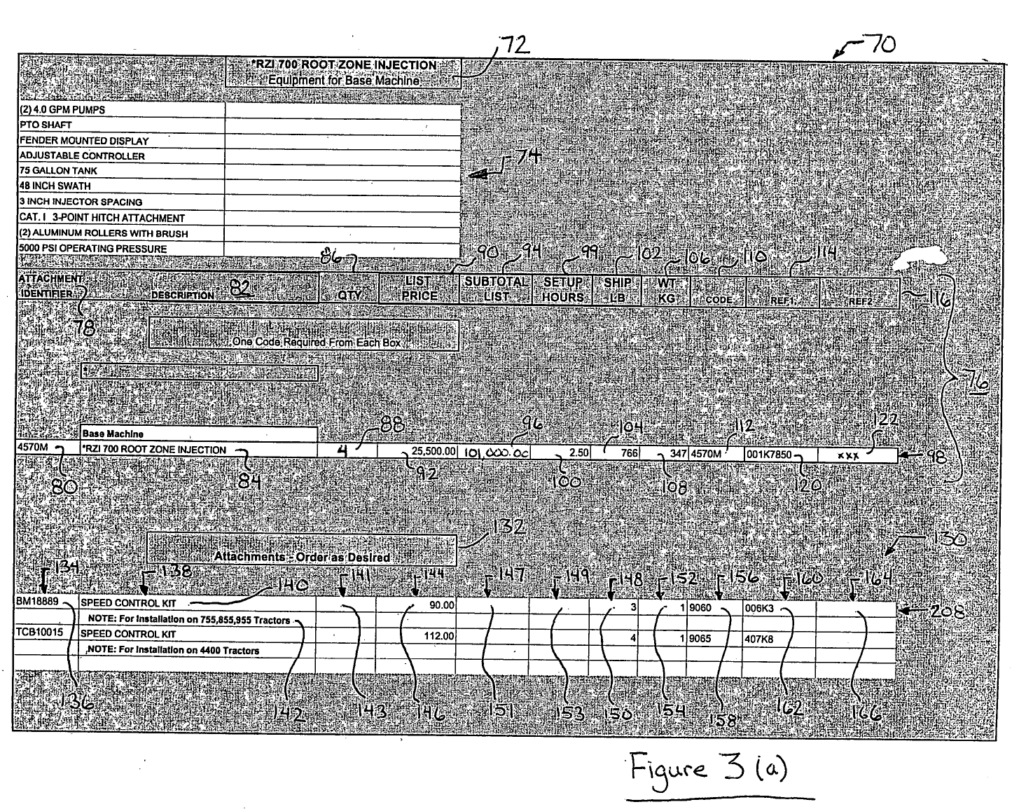

Referring now to FIG. 2, there is shown a screen of information 30 which may be resident within either of the portions 14 and/or 16. Alternatively, informational screen 30 may be placed within a portion which is distinct from either of portions 14 and 16 but which operatively resides within the computer 12 and which may be selectively accessed by a user.

As shown, informational screen display portion 30 includes a first item of information 32 which represents a succinct summary of the contained information and may include, by way of example and without limitation, the name of the dealer. Display portion 30 further includes a second item of information 34 which identifies the name of the dealer, and a third item of information 36 which identifies the address of the dealer. Screen display portion 30 further includes portions 38, 40, and 42 which respectively identify the city that the dealer resides within, the state that the dealer resides within, and the telephone number of the dealer. Screen display portion 30 further includes portions 44, 46, and 48 which respectively identify the telephone number of the “contact person” or the person that the customer interacts with, the postal code or “zip code” of the dealer, and the telefacsimile number of the dealer. Screen display portion 30 further includes portions 50, 52, and 54 which respectively represent the electronic mail address of the dealer, the “setup” labor rate which is usually charged by the dealer to a customer, and the percentage of the material price which is charged by the dealer to its customer for “handling” the equipment. In the preferred embodiment of the invention, each dealer or user of the computer system 10 has a unique information screen of information which is stored within the computer 10. In this manner, a user of the computer 12 may quickly and efficiently access all of the pertinent dealer information and use the information to efficiently prepare a quotation.

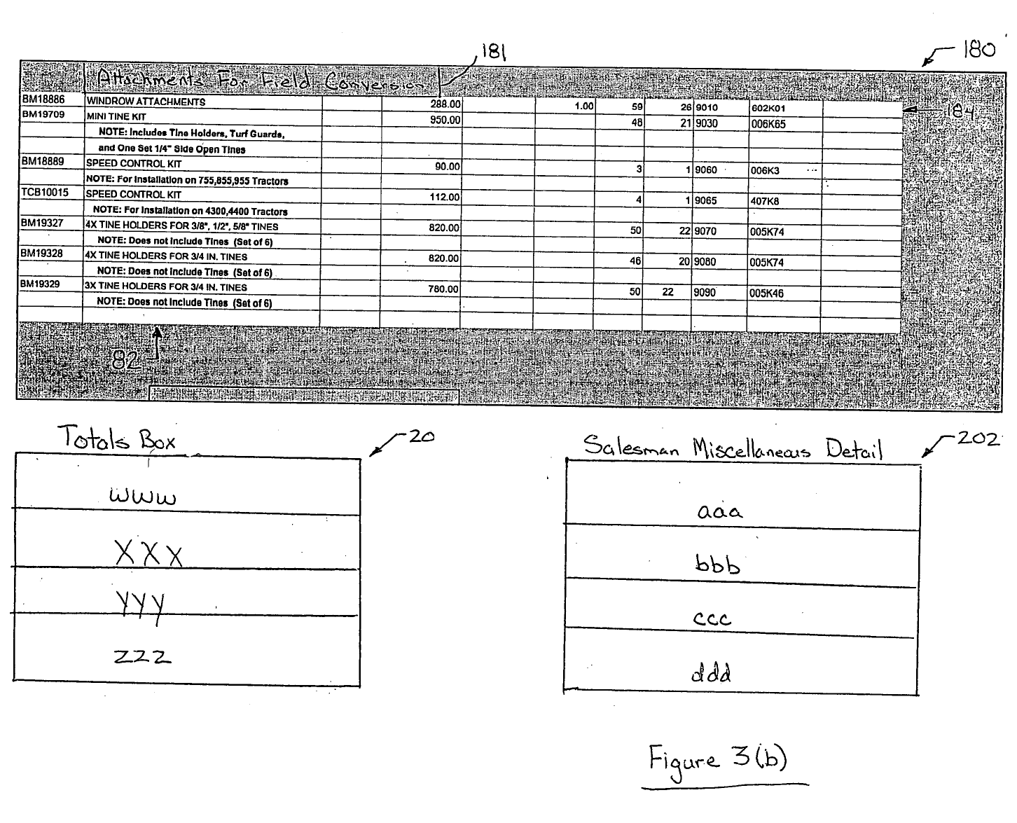

Referring now to FIGS. 3(a-b), there is shown an informational screen of information 70 having informational portions or entries which are stored within the computer 12 and which may be selectively accessed by a user of the computer 12 and thereafter presented to the user of the computer 12 in the form which is shown by the screen 70. In the preferred embodiment of the invention, each product which is provided or sold by the user of the computer system 10 has a unique screen display 70 which is selectively displayed to the user in the manner which is shown in FIG. 3(a).

Particularly, informational screen display 70 includes a first entry or informational portion 72 which generally identifies the product or assembly for which the remaining information which is included within the display 70 is associated with. Display 70 further includes an informational display portion 74 which identifies the various features and functionalities which are included in and/or are provided by the product or the assembly which is delineated within the entry or informational portion 72.

Informational screen display 70 further includes a portion 76 which delineates information associated with the product or device which is referred to in the portion 72. Portion 76 identifies required products or equipment that must be selected in order to generate a quote. In one non-limiting embodiment, portion 76 comprises at least one line of information 98 which is grouped in at least one “sub-section”. For each sub-section within portion 76, one line 98 must be selected to generate a quote. Portion 76 comprises various descriptive headings to identify the information within lines 98. Particularly, portion 76 includes a first descriptive heading 78 which is entitled “attachment identifier” and which includes an entry, such as entry 80, identifying the manufacturer's model number or some other unique number which is associated with the product which is referenced in portion 72. Further, portion 76 includes a second descriptive heading 82 which is entitled “description” and which includes an entry, such as entry 84, which generally describes the product which is referenced within the portion 72. Portion 76 also includes a third descriptive heading 86 which is entitled “quantity”. If the corresponding line 98 is selected, an entry 88 which, as is more fully explained below, is required to be dynamically placed within portion 70 by the quotation creator and which identifies the number of products, described by the entry 84, that are being “quoted”.

Portion 76 further includes a descriptive heading 90 which is entitled “list price” and which requires an entry, such as entry 92, identifying the list price of the product described within the portion 84. Portion 76 further includes a descriptive heading 94 which is entitled “subtotal list” and which requires an entry, such as entry 96, which is the mathematical product of the entry 88 and 92 which respectively appear on the same row of information 98 as does the entry 96. Portion 76 further includes a descriptive heading 99′ which is entitled “setup hours” and which requires an entry, such as entry 100, which approximates the number of hours required to properly install and “setup” the product referred to by entry 84 which appears within the same row of information 98 as does the entry 100.

Portion 76 further includes a descriptive heading 102 which is entitled “ship lb” and which contains an entry, such as entry 104, which delineates the weight of the product (in terms of pounds) which is referenced by the entry 84 within the row 98. Portion 76 further includes a descriptive heading 106 which is entitled “wt kg” and which contains an entry, such as entry 108, which delineates the weight of the product (in terms of kilograms) which is referenced by the entry 84 within the row 98. Portion 76 also includes a descriptive heading 110 which is entitled “code” and which contains an entry, such as entry 112, which represents a unique code which may be assigned to the product which is referenced by the entry 84 within the row 98 and which may, in one non-limiting embodiment, represent a model number or production number. Portion 76 further includes descriptive headings 114 and 116 which are respectively referred to as “REF1” and “REF2” and which respectively contain an entry, such as entries 120 and 122. Particularly, entries 120 and 122 cooperatively allow two additional unique codes to be attached to the product which is referenced by the entry 84 appearing within the informational row 98. In one non-limiting embodiment, entry 120 comprises encoded cost information which may be used by the manufacturer or dealer to process an order or to verify the accuracy of a quote. In this embodiment, entry 122 is an extension of entry 120 providing for the quantity entry 88 and which is used in the salesman miscellaneous detail 202 to determine the dealer's cost.

Informational screen 70 further includes a display portion 130 which includes a descriptive header 132 which is entitled “attachments-order as desired” and which, as is more fully delineated below, is used to succinctly and efficiently list the various additional components or “attachments” which the product, referenced by the entry 80 within row 98, may optionally utilize.

As shown, display portion 130 includes a first column of information 134 having entries, such as entry 136, which identifies the model number, part number, or other identification number of one such attachment or component. In one non-limiting embodiment, entry 136 may include the part number of a distinctly different, but related, attachment. Display portion 130 further includes a second column of information 138 having entries 140, 142. Particularly, an entry 140 appears within the same row of information as a unique one of the entries appearing within the column 134 and describes the attachment or component represented by the entry, such as entry 136. Further, entry 142 clarifies the use of the attachment which is referenced by the entry 140 appearing just above the entry 142. Display portion 130 further includes a third column of information 144 which appears under the descriptive heading 90 and this third column of information includes entries 146. Particularly, each entry 146 represents the list price of the item which is referred to by the entry 136 which appears within the same informational row as the entry 146.

Display portion 130 further includes a fourth column of information 148 which appears under the descriptive heading 102 and which includes entries 150. Particularly, an entry 150 represents the shipping weight (in terms of pounds) of the component or attachment which is identified by the entry 136, which appears within the same informational row as the entry 150. Display portion 130 further includes a fifth column of information 152 which appears under the descriptive heading 106 and which includes entries 154. Particularly, an entry 154 represents the weight (in terms of kilograms) of the component or attachment which is identified by the entry 136 which appears within the same informational row as does the entry 154.

Display portion 130 further includes a sixth column of information 156 which appears under the descriptive heading 110 and which has entries 158. Particularly, an, entry 158 uniquely identifies the component or attachment which is referred to by the entry 136 which appears upon the same row of information as does the entry 158 and, in one non-limiting embodiment, may represent a production or shipping code. Display portion 130 further includes a seventh column of information 160 which appears under the descriptive heading 114 and which includes entries 162. Particularly, an entry 162 represents another unique code which may be ascribed to the component or attachment which is represented by the entry 136 which appears upon the same row of information as does the entry 162. In one non-limiting embodiment, entry 162 comprises encoded cost information substantially the same as the type delineated for entry 120 above. It should be understood that display portion 130 contains columns of information 134-164, which are substantially equivalent to the columns 78-116 of portion 76. These columns 134-164 may be intentionally left blank (e.g., entry 153: “setup hours”) or may require dynamic user input (e.g., entry 143: “quantity”) for a particular product or item.

In one non-limiting embodiment of the invention, informational screen 70 further includes a third display portion 180, having a descriptive header portion 181 which reads “attachments for field conversions” and which has several columns of information 182 and several entries 184. In one non-limiting embodiment of the invention, the informational columns of the display portion 180 are substantially similar to the informational columns of the display portion 130. However, in contrast to the entries of the columns 134, 138, 144, 148, 152, 156, and 160, the entries in the columns 182 correspond to items, components, and attachments which are used to convert existing equipment in order to allow them to substantially correspond in functionality to the device represented by the entry 84.

Display portion 180 further includes a portion 200 which is entitled “totals box” and which includes information about the equipment which is shown in portions 76 and 130 and which is more fully and completely delineated below and a portion 202 which is referred to as “salesman miscellaneous detail” and which is further delineated below.

In operation, a sales professional desiring to generate a quotation for equipment or to enter new data and/or information on the equipment selects the informational display portion, such as informational display portion 70, for the equipment which is desired to be quoted or edited. When adding new information, a new sub-section of lines 98 may be added to a screen 70 by the salesman by generating at least one blank pre-formatted line 98 that may then be dynamically edit as desired.

In one non-limiting embodiment of the invention, computer 12 includes a directory portion 204, as shown in FIG. 1, which lists all of the various diverse types or models of equipment for which the sales professional may provide a quotation. This list may be arranged in alphabetical order and may be selectively searched by the use of a keyword (e.g., by model number or manufacturer name).

The sales professional then selectively accesses each of the display portions, such as screen display portion 70, and performs the activities which are more fully delineated below with respect to the display portion 70.

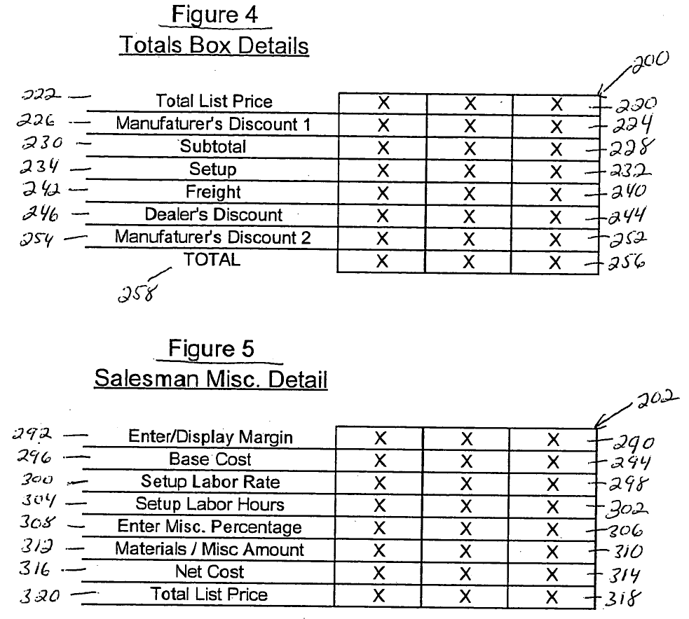

That is, upon “opening” or accessing the portion 70 and causing the portion 70 to be selectively displayed upon the computer 12, the sales professional then determines the quantity of the product to be quoted and places a corresponding number under the heading 86 (i.e., represented as entry 88). The other entries 80, 84, 92, 96, 100, 104, 108, 112, 120, and 122 within the row 98 are already provided by the computer 12. In one non-limiting embodiment of the invention, these entries 80, 84, 92, 96, 100, 104, 108, 112, 120, and 122 within the row 98 may be inputted manually, downloaded off of a compact disc, or off of the Internet 22. Similarly, the sales professional selectively places a quantity entry into column 141 of display portion 130 and within a row 208 including the entry 136 corresponding to the attachment which is to be ordered. Similarly, the sales professional selectively places a quantity entry into the row 184 of display portion 180 corresponding to the desired field conversion assembly. After the quantities are selectively placed into display portion 70, the sales professional may selectively depress an “enter key” which is provided by the computer 12 or selectively depress a mouse-provided cursor. Upon such an activity, computer 12 is adapted to provide a total list price of all selected entities and their respective quantities. The total list price is represented as an entry 220 and appears upon the same row as the heading “total list price” 222, as shown in FIG. 4. Further, a desired manufacturer's discount is inputted which is based, by way of example and without limitation, upon the identity of the customer (e.g., the purchasing history of the customer), and/or upon the identity of the selected items, and/or on “special offers” from the product's manufacturer. This discount is dynamically inputted by the salesman and is used to form an entry 224 which appears upon the same row of information as the heading 226 which is entitled “manufacturer's discount 1”. The computer 12 is then adapted to provide an entry 228 which appears upon the same row of information as the heading 230 which is entitled “subtotal” and which, in one non-limiting embodiment of the invention, represents a mathematical subtraction of entry 224 from entry 220.

Further, computer 12 is adapted to automatically provide an entry 232 which appears upon the same informational row as the heading 234 which is entitled “setup”. Particularly, entry 232 represents the total “setup” charges which are associated with the quantity of equipment, components, assemblies, and attachments which have been selected. For example, this entry 232 is based upon the number of hours which are represented by entry 100 and by the number of such machines which are to be provided as represented by the entry 88 this figure is then mathematically multiplied by the “setup” labor rate 52. Similar hourly information may be provided, in other non-limiting embodiments of the invention, by the use of entries 143 and 153 within portions 130 and 180. Moreover, computer 12 is also adapted to provide an entry 240 which appears upon the same informational row as the heading 242 which is entitled “freight”. Particularly, entry 240 represents the total freight charges associated with the shipment of the quoted equipment, attachments, and/or assemblies to a location desired by the customer and is based, in part, upon the weight of the desired material as found, for example and without limitation, under the headings 102 and/or 106.

Computer 12 further automatically provides an entry 244 which is provided in the same informational row as the heading 246 which is entitled “dealer's discount” and represents a discount to be given by the dealer (e.g., the organization that employs the sales professional) that is either manually inputted or is automatically calculated and such a discount may be based upon the identity of the customer (e.g., the purchasing history of the customer) and/or upon the type of equipment, assemblies, and/or devices which are quoted. In one non-limiting embodiment, discount 246 may be entered as either a fixed amount or as a percentage. Computer 12 further provides an entry 252 which is placed in the same informational row as the heading 254 entitled “manufacturer's discount 2” and which represents an manually inputted manufacturer's discount or reduction which is to be applied to the total sale and which, by way of example and without limitation, is based upon the identity of the customer (e.g., the purchasing history of the customer), and/or the type of products or materials which are quoted, and/or the type of manufacturer's special offers available. Computer 12 then generates an entry 256 upon the same row of information as the heading 258 which is entitled “total”. Particularly, entry 256 represents the sum of entries 228, 232, 240 and the subtraction of entries 244 and 252 from this sum and represents the total amount of money that the customer shall pay for the quoted material or equipment. Hence, the portion 200 is substantially automatically generated, by computer 12 (i.e., the term “automatic” means that portion 200 is created by the computer 12 and not by the sales professional), while leaving the discounts 224, 244, and 252 to be dynamically inputted.

Screen display 70 further includes a portion 202, as is more clearly shown in FIG. 5, which is entitled “salesman miscellaneous detail” and which has a first entry 290 which appears upon the same row of information as the heading 292 which is entitled “enter/display margin”. Particularly, entry 290 represents the profit margin which the dealer is to obtain from the sale of the product which is referenced by the entry 84. This margin entry 290 may be provided to the computer 12 by the dealer/manufacturer automatically or may be dynamically entered by the sales professional. In one non-limiting embodiment of the present invention, the sales professional may optionally and dynamically input the desired margin amount or percentage into entry 290 and thereby automatically calculate the resulting discounts 224, 244, and/or 252.

Portion 202 further includes a second entry 294 which appears upon the same informational row as the heading 296 which is entitled “base cost”. Particularly, entry 294, which is provided by the dealer to the computer 12, represents the cumulative costs to the dealer of obtaining the item which is described by the entry 84 of the selected lines 98 and their associated components or attachments (if any). Portion 202 further includes a third entry 298 which resides within the same row of information as the heading 300 which is entitled “setup labor rate”. Particularly, entry 298, which is provided by the dealer to the computer 12, represents the hourly cost of labor for “setting up” the machine which is referenced by the entry 84 and its associated components or attachments.

Further, portion 202 includes an entry 302 which appears upon the same row of information as the heading 304 which is entitled “setup labor hours”. Particularly, entry 302, which is calculated by computer 12, represents the cumulative number of hours actually required to “setup” or operationally assemble the machine or equipment which is represented by the entry 84 and its associated components or attachments. Portion 202 further includes an entry 306 which appears within the same row of information as the heading 308 which is entitled “enter mtls/misc percentage”. Particularly, an entry 306 represents a percentage applied against the net cost which is represented as entry 92, which is to be applied as a miscellaneous price adjustment. Portion 202 further has an entry 310 which appears upon the same row of information as the heading 312 which is entitled “materials/miscellaneous amount”. Particularly, an entry 310 represents a fixed amount, as opposed to the percentage entry 306, which should be added to the total cost.

Portion 202 further includes an entry 314 which appears within the same row of information as the heading 316 which is entitled “net cost”. Particularly, entry 314 represents the total cost to the dealer for the equipment which is referenced by the entry 84. Further, portion 202 includes an entry 318 which appears upon the same row of information as the heading 320 which is entitled “total list price” and which, in one non-limiting embodiment of the invention, is substantially equal to the sum of the various “subtotal list” entries 96 and their associated components or attachments “subtotal list entries” 151.

The information contained within the portion 202 represents a summary of the calculated sums of the various columns depicted in FIG. 3 (e.g., subtotal list price 94 and setup hours 99) and which further allows the sales professional to dynamically alter or change the provided list price, found for example by entry 92, while maintaining some margin or profit.

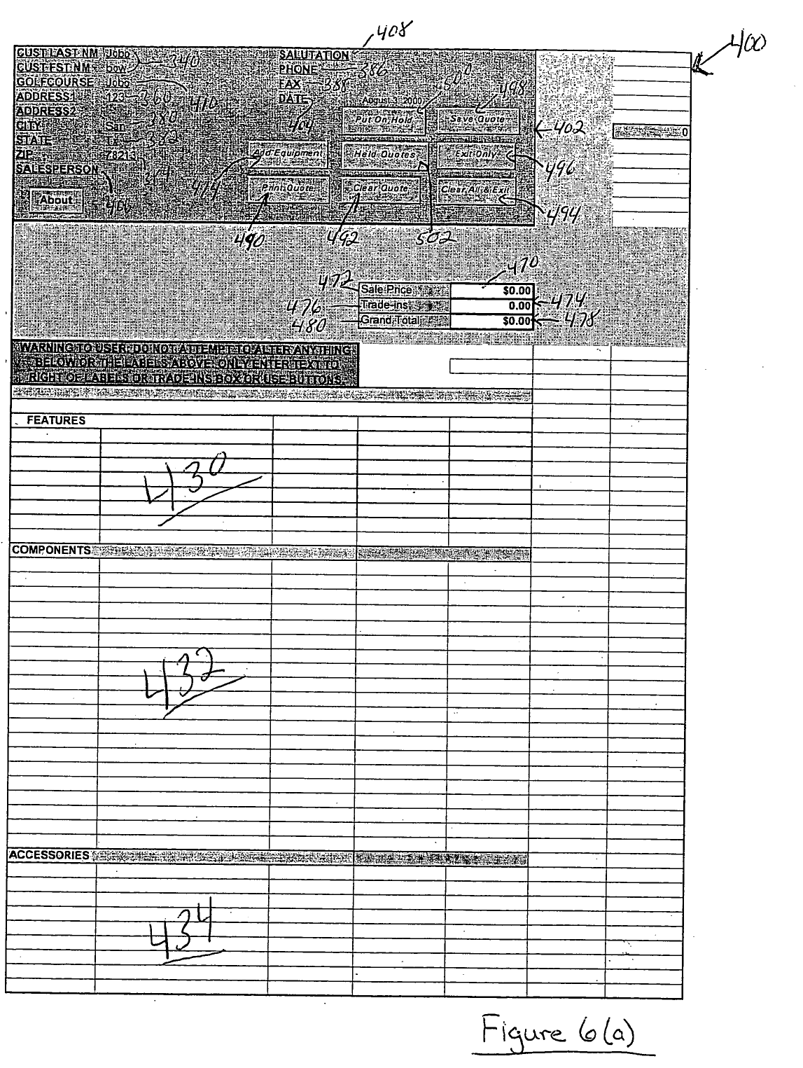

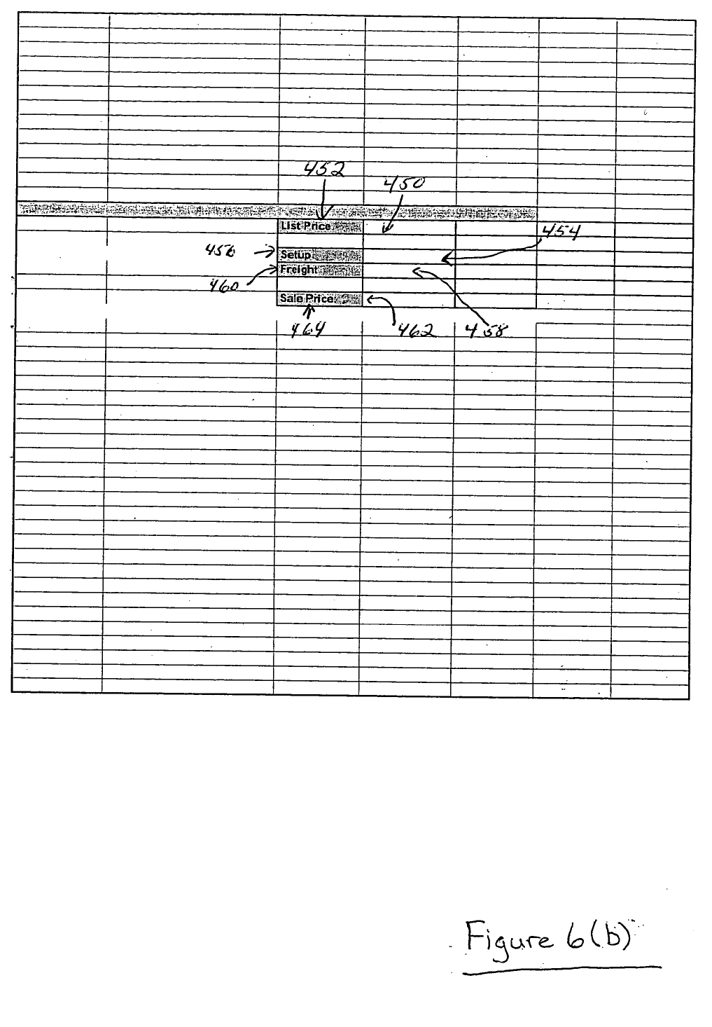

To further understand the use of the system 10, reference is now made to the quote template or informational display portion 400 which is shown in FIGS. 6(a-b) and which is selectively displayed to a user of the computer 12.

Particularly, template 400 includes a first portion 402 which may, in one non-limiting embodiment, be created by the dynamic insertion of entries 340, 360, 380, 382, 384, 386, and 388. That is, in this non-limiting embodiment, the sales professional manually inputs these entries into the portion 402 by use of a keyboard. Entry 340 depicts the customer's name. Entries 360-384 depict the customer's address. Entries 386 and 388 depict the customer's telephone and telefacsimile numbers, respectively. Entry 404 depicts the current date and is automatically updated by the computer 12. Furthermore, entries 406 and 408 may be manually placed into the portion 402 by the sales professional and respectively correspond to the identity of the sales professional who is preparing the quotation and the salutation to be afforded to the customer or contact individual. Moreover, in yet another non-limiting embodiment of the invention, portion 402 may have yet another entry 410, which provides a customer's business name or describes the nature of the business which is conducted by the customer.

Hence, once it is determined that a quotation is to be created, a template 400 is accessed by the sales professional and displayed upon the computer 12 The sales professional then dynamically inputs the customer information 340-388 of the customer for whom the quotation is to be generated. After these tasks are completed, the sales professional determines the equipment which is to be quoted and accesses and displays the corresponding equipment sheets after selecting the “add equipment” entry 414 of portion 402 by use of a cursor or by the use of a keystroke. After this entry is selected, the computer 12 allows the sales professional to selectively access and display equipment pages, such as page or informational display portion 70. Selections of portions of the displays, such as display 70, are made and automatically copied or transferred onto the quotation template 400. That is, each entry 74, which is selected, is transferred or placed or referenced by an entry in portion 430 of the quotation template 400. Each entry contained within line 98 that is selected is transferred, placed, and/or referenced by an entry within portion 432 of the quotation template 400. Further, each entry within a row 208 of display portion 130 and/or row 184 of display portion 180 which are selected are transferred, placed, and/or referenced by an entry within portion 434. In this manner, the quotation template is automatically created upon the selection of various portions of the equipment display portions 70.

The quotation template 400 further has an entry portion 450 which appears upon the same row of information as the heading 452 which is entitled “list price.” and which represents the total list price of all of the selected components, materials, and/or equipment. The quotation template 400 further has an entry portion 454 which appears upon the same row of information as the heading 456 which is entitled “set up”. Particularly, the entry 454 comprises or represents the total amount of “set up” charges for the equipment, components, and materials which are referenced above it and included within the quotation template 400. The quotation template further has an entry portion 458 which appears upon the same row of information as the heading 460 which is entitled “freight”. Particularly, the entry 458 represents the total freight charge for the equipment, components, and materials which are referenced above it and included in the quotation template 400. The quotation template 400 further includes an entry portion 462 which appears upon the same row of information as the heading 464 which is entitled “sale price” and which represents the total price, after the application of all respective and associated and previously delineated discounts, for each of the quoted equipment, components, and materials and, in one non-limiting embodiment of the invention, represents the sum of all of the respective entries 256 for each of the quoted equipment, components, and materials.

It should be understood that portions 430, 432, and 434 delineate information for only a single product that is represented by a copy of a display portion 70 and its associated components or accessories. If more than one required item is selected (e.g., there is more than one sub-section of required equipment within portion 76), separate portions 430-434 will be generated for each different piece of equipment or component that is represented by a display portion 70.

The quotation template 400 further includes an entry 470 which summarizes or is substantially equal to the sum of the entries 462 for each selected “required” item(s) and its associated components or attachments, and which is on the same row of information as the heading 472 which is entitled “sale price”. The quotation template 400 also includes an entry 474 which appears within the same informational row of information as the heading 476 which is entitled “trade-ins”. Particularly, the entry 474 represents the value of all equipment, components, and materials which have been brought to the dealer from the customer and for which credit is to be given. Quotation template 400 further includes an entry 478 which appears upon the same row of information as the heading 480 which is entitled “grand total” and which has a value which is substantially equal to the difference of the value of entry 470 and the value of entry 474.

Quotation template 400 also includes a selectable entry 490 which, upon its selection by a mouse or a keystroke, causes the computer 12 to print the quotation template 70. Further, the quotation template 400 also includes a selectable entry 492 which, upon its selection by a mouse or a keystroke, causes the computer 12 to “clear” or destroy all of the entries which have been transferred to template 400. The quotation template 400 further includes a selectable entry 494 which, upon its selection by a mouse or a keystroke, causes the computer 12 to clear or destroy all of the entries which have been transferred to the template 400 plus all associated template 70 copies and to exit the quotation portion or quotation generation portion 14 of the computer 12. The quotation template 400 further includes a selectable entry 496 which, upon its selection by a mouse or a keystroke, causes the computer 12 to exit the quotation portion or the quotation generation portion 14 of the computer 12. The quotation template 400 further includes a selectable entry 498 which, upon its selection by a mouse or a keystroke, causes the computer 12 to save the created quotation template 400 and all copies of the equipment templates 70 to a disk or other storage medium for further use.

The quotation template 400 further includes a selectable entry portion 500 which, upon its selection by a mouse or by a keystroke, causes the computer 12 to “put the quotation on hold” which, in one non-limiting embodiment of the invention, causes the quotation template 400 and all associated template 70 copies to be stored in a directory which is referenced by the customer name. The quotation template 400 further includes a selectable entry portion 502 which, upon its selection by a mouse or keystroke, enables the computer 12 to display all of the quotation templates 400 which have been placed on hold. This feature allows the user to access, review, and/or edit all of the quotes previously put on hold.

It is to be understood that the invention is not limited to the exact construction which has been delineated above, but that various changes and modifications may be made without departing from the spirit and the scope of the inventions as are more fully set forth in the following claims.

1-16. (canceled)

17. A computerized quotation system including a predefined quotation template; and a plurality of equipped pages which may be accessed after said quotation template is accessed and which includes product information which may be selectively and automatically placed upon said quotation template.
